(19) United States
(12) Patent Application Publication
(10) Pub. No.: US 2026/0065872 A1
(43) Pub. Date: Mar. 5, 2026

(54) DISPLAY DEVICE AND DRIVING METHOD THEREOF

(71) Applicant: TCL CHINA STAR OPTOELECTRONICS TECHNOLOGY CO., LTD., Shenzhen (CN)

(72) Inventors: Shuming CHANG, Shenzhen (CN); Yoongu KIM, Shenzhen (CN); Xintian SU, Shenzhen (CN); Jiajia CHEN, Shenzhen (CN); Xiaoying GUO, Shenzhen (CN); Qiqi LIN, Shenzhen (CN); Fan CHEN, Shenzhen (CN); Lina WANG, Shenzhen (CN)

(73) Assignee: TCL CHINA STAR OPTOELECTRONICS TECHNOLOGY CO., LTD., Shenzhen (CN)

(21) Appl. No.: 18/934,114

(22) Filed: Oct. 31, 2024

(30) Foreign Application Priority Data
Sep. 5, 2024 (CN) 202411247649.3

(51) Int. Cl. G09G 3/36; G09G 3/20

(52) U.S. Cl. CPC G09G 3/3677; G09G 3/2096; G09G 3/3607; G09G 2300/0408; G09G 2300/0452; G09G 2310/08; G09G 2320/0242

(57) ABSTRACT

A display device and a driving method thereof are provided. The driving method includes the following steps: simultaneously controlling switches of an M-th row of sub-pixels and a (M+2)-th row of sub-pixels to be turned on or off, and sequentially controlling switches of four adjacent rows of the same color sub-pixels to be turned on or off.

### CROSS-REFERENCE TO RELATED APPLICATIONS

This application claims priority to Chinese Patent Application No. 202411247649.3 filed on Sep. 5, 2024. The disclosure of the aforementioned application is incorporated herein by reference in its entirety.

### TECHNICAL FIELD

The present disclosure relates to the technical field of display, and particularly relates to a display device and a driving method of the display device.

### BACKGROUND

The conventional gate driving architecture refers to the one gate line and one data line (1G1D) architecture. In order to reduce costs, large-size and high-resolution display devices adopt a triple gate (tri-gate) driving architecture. In the triple gate driving architecture, the number of data lines decreases to one third of the conventional gate driving architecture, and the number of scanning lines increases to three times that of the conventional gate driving architecture, resulting in the charging time of a single pixel in the display panel of the triple gate driving architecture decreasing to one third of the charging time of a single pixel in the display panel of the conventional gate driving architecture. It can be seen that the charging time of pixels in the triple gate driving architecture is seriously insufficient, which can easily lead to image quality problems.

### SUMMARY

The embodiments of the present disclosure provide a driving method of a display device, the display device includes a display panel including a plurality of scanning lines, a plurality of data lines, and a plurality of sub-pixels arranged in an array, each of the sub-pixels is electrically connected to one of the scanning lines and one of the data lines, colors of a same row of the sub-pixels are same, colors of adjacent rows of the sub pixels are different, one of the data lines is electrically connected to three consecutive sub-pixels having different colors in a column of the sub-pixels, and is further electrically connected to another three rows of three consecutive sub-pixels having different colors in another adjacent column of the sub-pixels; and
the driving method includes:
controlling a switch of a (M+1)-th row of the sub-pixels to be turned on or off; and
simultaneously controlling switches of M-th row of the sub-pixels and switches of a (M+2)-th row of the sub-pixels to be turned on or off, and sequentially driving switches of four adjacent rows of the sub-pixels having a same color to be turned on or off;
where a turned-on time of the switches of the M-th row of the sub-pixels is later than a turned-on time of the switches of the (M+1)-th row of the sub-pixels; and M is a positive integer and M+2 is a multiple of 3.

Accordingly, the embodiments of the present disclosure provide a display device, including a display panel, a source driving circuit, a gate driving circuit, and a timing controller, where the timing controller is electrically connected to the source driving circuit and the gate driving circuit, the display panel includes a plurality of scanning lines, a plurality of data lines, and a plurality of sub-pixels arranged in an array, the source driving circuit is electrically connected to the data lines, the gate driving circuit is electrically connected to the scanning lines, each of the sub-pixels is electrically connected to one of the scanning lines and one of the data lines, colors of a same row of the sub-pixels are same, colors of adjacent rows of the sub pixels are different, one of the data lines is electrically connected to three consecutive sub-pixels having different colors in a column of the sub-pixels, and is further electrically connected to another three rows of three consecutive sub-pixels having different colors in another adjacent column of the sub-pixels; and
the timing controller is configured to:
controlling switches of a (M+1)-th row of the sub-pixels to be turned on or off; and
simultaneously controlling switches of M-th row of the sub-pixels and switches of a (M+2)-th row of the sub-pixels to be turned on or off, and sequentially driving switches of four adjacent rows of the sub-pixels having a same color to be turned on or off;
where a turned-on time of the switches of the M-th row of the sub-pixels is later than a turned-on time of the switches of the (M+1)-th row of the sub-pixels; and M is a positive integer and M+2 is a multiple of 3.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a 1G1D driving architecture provided by some embodiments of the present disclosure.

FIG. 2 is a schematic diagram of a triple gate driving architecture provided by some embodiments of the present disclosure.

FIG. 3 is a schematic diagram of a line over drive look up table (LOD LUT) provided by some embodiments of the present disclosure.

FIG. 4 is a schematic diagram of color shift of a color mixing pattern provided by some embodiments of the present disclosure.

FIG. 5 is a schematic diagram of charging compensation provided by some embodiments of the present disclosure.

FIG. 6 is a schematic diagram of a clock signal provided by some embodiments of the present disclosure.

FIG. 7 is a schematic diagram of a gate on array (GOA) driving timing provided by some embodiments of the present disclosure.

FIG. 8 is a schematic diagram of a driving effect provided by some embodiments of the present disclosure.

FIG. 9 is a schematic diagram of a gate driving unit provided by some embodiments of the present disclosure.

FIG. 10 is a schematic diagram of a GOA timing provided by some embodiments of the present disclosure.

FIG. 11 is a schematic diagram of a charging effect provided by some embodiments of the present disclosure.

FIG. 12 is a schematic diagram of another clock signal provided by some embodiments of the present disclosure.

FIG. 13 is a schematic diagram of another clock signal provided by some embodiments of the present disclosure.

FIG. 14 is a schematic diagram of another GOA timing provided by some embodiments of the present disclosure.

FIG. 15 is a schematic diagram of another charging effect provided by some embodiments of the present disclosure.

FIG. 16 is a schematic diagram of another gate driving unit provided by some embodiments of the present disclosure.

### DETAILED DESCRIPTION

The technical solutions in the embodiments of the present disclosure will be described hereinafter with reference to the accompanying drawings. The described technical solutions are merely for explaining and illustrating the ideas of the present disclosure, and should not be construed as limiting the scope of protection of the present disclosure.

In addition, “a plurality of” in the embodiments of the present disclosure refers to two or more. “First”, “second” and the like in the embodiments of the present disclosure are used to distinguish different technical features, and do not indicate any order, quantity, or importance.

The various embodiments provided by the present disclosure are similar, and features in different embodiments may be combined with each other.

The order of description of the following embodiments is not intended to limit the preferred order of the embodiments.

The liquid crystal display is the most widely used flat panel display at present, and has gradually become a display with high-resolution color screen widely used in various electronic devices such as television, mobile phone, personal digital assistant (PDA), digital camera, tablet or notebook computer screen.

As shown in FIG. 1, it is a schematic diagram of a conventional 1G1D driving architecture of a liquid crystal display. The display panel based on the conventional 1G1D driving architecture includes a plurality of red sub-pixels R, green sub-pixels G and blue sub-pixels B arranged in a vertical array. D1 and D2, etc. represent a data line, respectively. G1 and G2, etc. represent a scanning line, respectively. Each column of sub-pixels is connected to respective one of the data lines, and each row of sub-pixels is connected to respective one of the scanning lines.

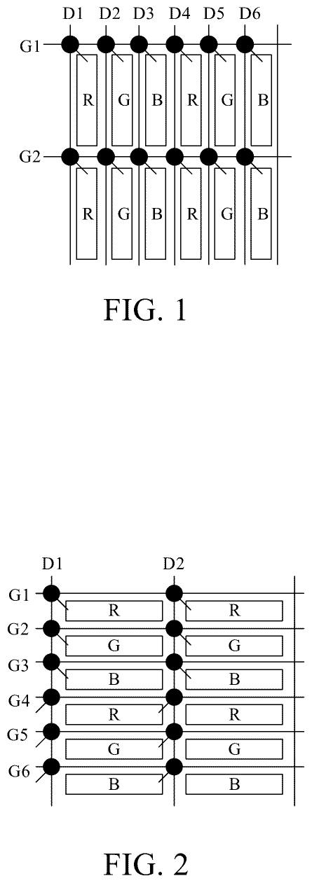

As shown in FIG. 2, the display device of the present disclosure is a triple gate driving architecture. In the triple gate driving architecture, the number of data lines is reduced to one third of that of the conventional 1G1D driving architecture, and the number of scanning lines is increased to three times that of the conventional 1G1D driving architecture. That is, the display panel based on the triple gate driving architecture includes a plurality of red sub-pixels R, green sub-pixels G, and blue sub-pixels B arranged in a horizontal array, each row of sub-pixels is connected to respective one of the scanning lines, and every three rows of sub-pixels are connected to respective one of the data lines. Therefore, the number of source driver chips of the triple gate driving architecture can be directly reduced by two-thirds to one-third of the conventional 1G1D driving architecture. But the charging time of each row of the triple gate driving architecture will be directly reduced to less than one-third of that of the conventional 1G1D driving architecture. The charging time is seriously insufficient, which will make the display brightness fail to meet expectations. In addition, due to the problem of resistance-capacitance delay in the display panel, in-plane luminance unevenness is prone to occur.

In order to improve the color shift problem caused by insufficient charging in heavy load images such as monochrome or mixed color images, line over drive (LOD) can usually be used for charging compensation. As shown in FIG. 3, it is an exemplary LOD look-up-table (LUT), which is divided into a rising area and a falling area. By comparing the gray scale difference between the current row and the previous row, the gray scale setting of the current row is changed to a value higher or lower than the ideal gray scale by looking for the LOD LUT, so that the corresponding pixel is finally driven to reach the actual target gray scale.

However, LOD tuning has a disadvantage in the conventional driving environment: the optimal LOD filling value cannot be accurately locked, resulting in the inability to take into account the gray scale combination of R/G/B mixing of multiple sub-pixels. Especially the triple gate driving architecture, which is sensitive to charging changes, is prone to watermarking and uneven transition image quality problems under a variety of complex patterns.

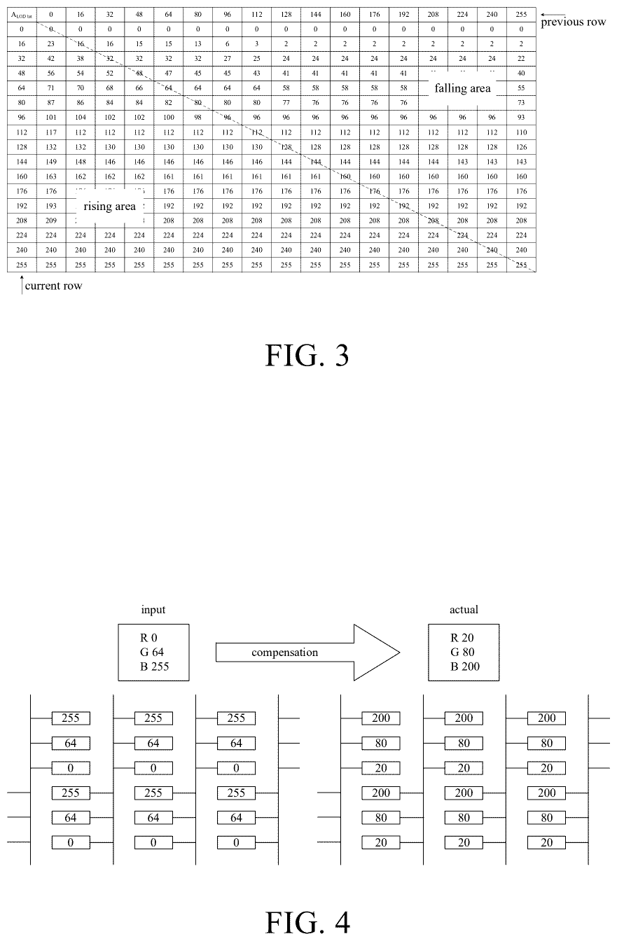

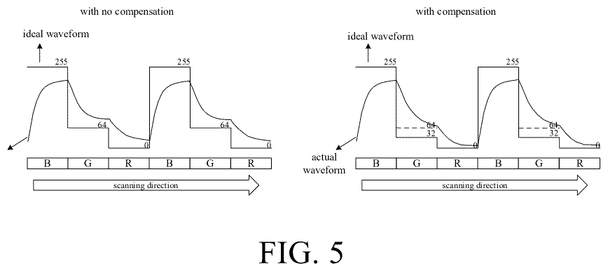

As shown in FIG. 4, assuming that the color mixing pattern input by the signal source is (0, 64, 255), without LOD charging compensation, after signal transmission and resistance-capacitance delay (RC Delay), the color mixing effect of (20, 80, 200) will eventually appear, which is significantly different from the target chromaticity. In the case of LOD charging compensation, as shown in FIG. 5, because the highest gray scale is 255 gray scale and the lowest gray scale is 0 gray scale, the corresponding 255 gray scale cannot be further overdriven upward, and the corresponding 0 gray scale cannot be further overdriven (OD) downward. Only the descent from 255 gray scale corresponding to the blue sub-pixel B to 64 gray scale corresponding to the green sub-pixel G can be overdriven. For example, the 64 gray scale corresponding to the green sub-pixel G is changed to 32 gray scale, but at this time, the adjacent previous row of blue sub-pixels B and the next row of red sub-pixels R in the next row actually fail to reach the target gray scale. The LOD determines the OD value mainly depends on brightness conversion. However, the brightness of adjacent rows interferes the brightness, which will result in LOD being unable to confirm the optimal filling value that can be adapted to multiple RGB combinations. If it is a color combination in which the gray scales of sub-pixels R/G/B can be overdriven, it will face multiple rising and falling overdrive adjustments, and the adaptability of LOD filling value is even worse, and only very few patterns can be taken into account.

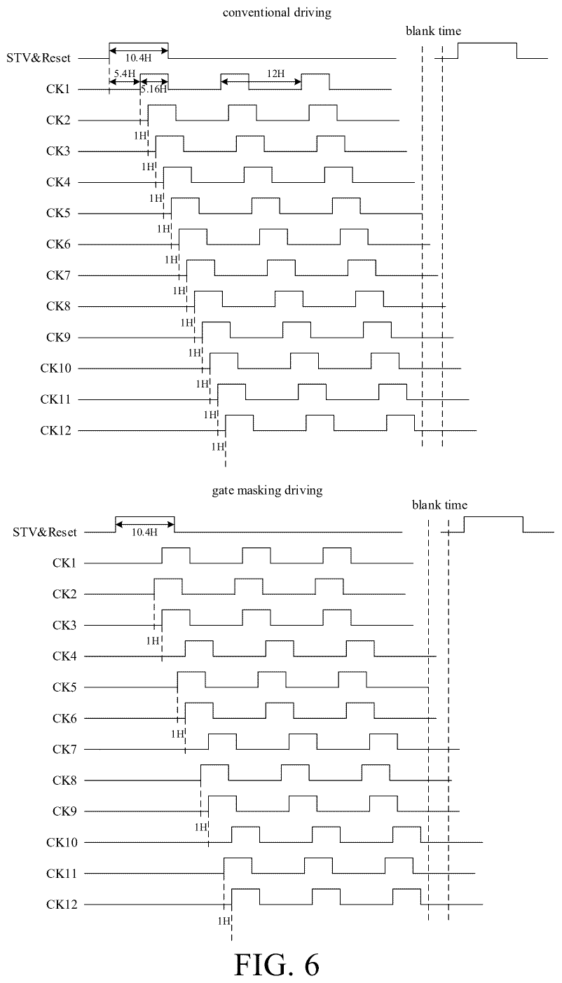

In order to achieve accurate compensation of triple gate LOD, the present disclosure provides a gate masking driving technology. As shown in FIG. 6, before LOD tuning is performed, the timing for driving GOA is changed from conventional driving to gate masking driving. The clock signal CK1 output to the display panel is changed to be consistent with the original clock signal CK3. The clock signal CK4 is changed to be consistent with the original clock signal CK6. The clock signal CK7 is changed to be consistent with the original clock signal CK9. The clock signal CK10 is changed to be consistent with the original clock signal CK12. The clock signals CK1, CK4, CK7, and CK10 all correspond to the blue sub-pixels B, and the clock signals CK3, CK6, CK9, and CK12 all correspond to the red sub-pixels R.

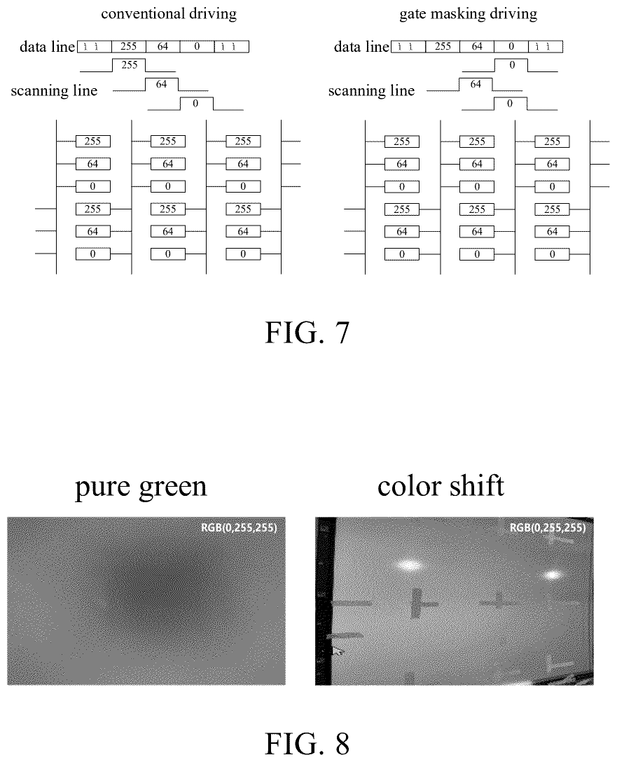

As shown in FIG. 7, in the condition that the red sub-pixel R is fixed to 0 gray scale, the input color mixing pattern under the gate masking driving is (0, x, y). Because the blue sub-pixel B is not turned on for charging, the picture finally only presents green color, excluding the brightness influence of adjacent colors. In this environment, a simple rising or falling environment may be quickly constructed by specially setting different G/B gray scale combinations, and the best fill value for all rising and falling in LOD LUT may be accurately obtained by comparing the brightness difference with the brightness difference under light load.

As shown in FIG. 8, the input color mixing pattern is (0,255,255) under the gate masking driving. Theoretically, the blue sub-pixel B is not charged because the corresponding switch is not turned on. The picture should show a pure green, but actually driving the display panel to display, an obvious color shift will occur. The color shift is most severe in the lower half screen close to the driving end, and the color shift is relatively mild in the upper half screen away from the driving end. The obvious color shift in this driving environment may not meet the optimization needs. This is because the aforementioned gate masking driving ignores the impact of GOA timing changes on GOA stage transmission and pixel charging.

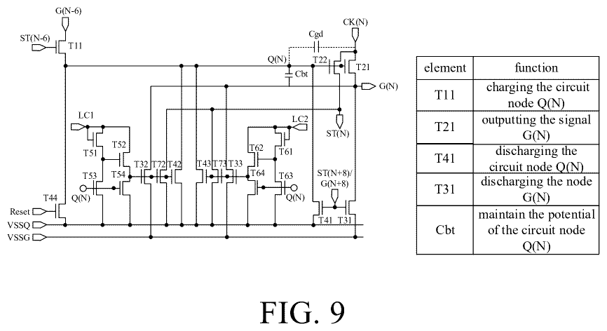

As shown in FIG. 9, it is a schematic diagram of a triple gate GOA driving circuit. A transistor T11 constitutes a pull-up control module. After a signal G(N−6) is input, a node Q(N) is pre-charged. A transistor T21 constitutes a pull-up module, and finally outputs a signal G(N). A transistor T31 and a transistor T41 constitute a pull-down module. When a signal G(N+8) comes, the node Q(N) is discharged and pulled down to a low potential VSSQ at the first time, and a node G(N) is discharged and pulled down to the low potential VSSG.

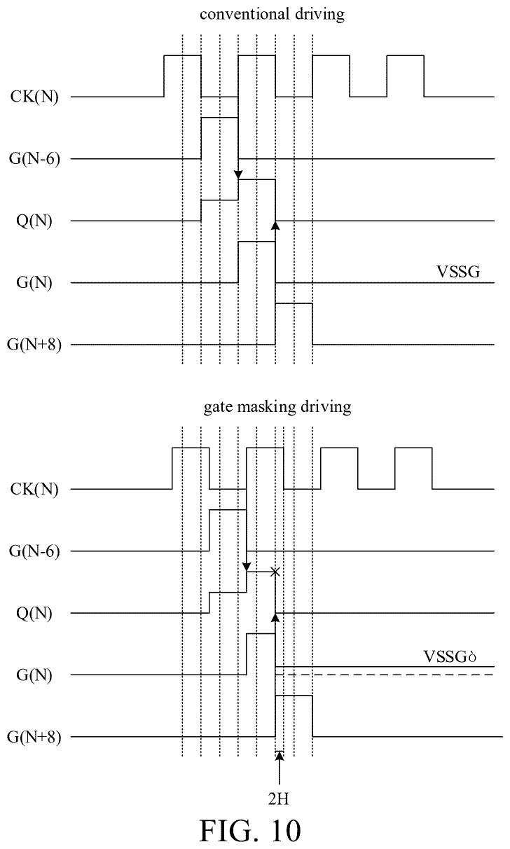

As shown in FIG. 10, based on a timing of the clock signal CK and the driving circuit of the GOA under the above conventional driving and gate masking driving, the specific working timing of the GOA corresponding to a row of the blue sub-pixels B is analyzed. Because the clock signal CK(N) corresponding to the blue sub-pixel B is shifted backward by two units of time as a whole under the gate masking driving, the signal G(N−6) received by the pull-up control module of the GOA corresponding to the signal G(N) also corresponds to the blue sub-pixel B and is shifted backward in synchronization with the signal G(N). The signal G(N+8) received by the pull-down module of the GOA corresponding to the signal G(N) corresponds to the red sub-pixel R and is actually not shifted. Therefore, after the pull-down module is turned on, the clock signal CK(N) is still outputting the high potential, and erroneous charging will occur, which eventually leads to the signal G(N) not being completely reduced to the original low potential VSSG, and the gate slew (signal conversion time) of the corresponding row of the blue sub-pixels B becomes smaller.

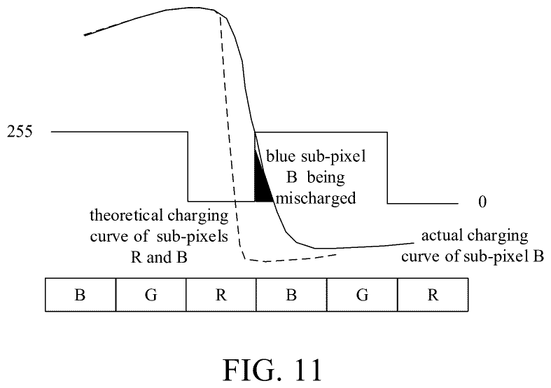

As shown in FIG. 11, under the gate masking driving, the scanning signals corresponding to the blue sub-pixel and the red sub-pixel are completely consistent in theory. But in fact, the blue sub-pixel B will be mischarged because the corresponding gate slew becomes smaller. The upper half of the screen is at the far end of the driving. Because the overall attenuation of the original data signal is serious, the mischarging of the blue sub-pixel is relatively slight. Finally, the phenomenon is that the color shift is serious at the near end of the driving and is slight at the far end of the driving.

In order to solve the serious side effect caused by the gate masking technology in practice, that is, color shift, the present disclosure improves the timing controller. The problem that line overdrive may not accurately charge and compensate in the triple gate driving architecture is improved. The accuracy and efficiency of charging compensation of liquid crystal displays is improved. The image quality problems of watermarks and uneven transitions under various complex RGB combination patterns is improved, so as to improve the overall image quality.

The display device provided by the embodiments of the present disclosure includes a display panel, a source driving circuit, a gate driving circuit, and a timing controller. The timing controller and the source driving circuit are electrically connected, and the timing controller and the gate driving circuit are electrically connected. The display panel includes a plurality of scanning lines, a plurality of data lines, and a plurality of sub-pixels arranged in an array. The source driving circuit is electrically connected to the data lines. The gate driving circuit is electrically connected to the scanning lines. Each sub-pixel is electrically connected to one scanning line and one data line. Colors of a same row of the sub-pixels are same, and colors of adjacent rows of the sub pixels are different. One of the data lines is electrically connected to three consecutive sub-pixels with different colors in a column of the sub-pixels, and is further electrically connected to another three rows of three consecutive sub-pixels with different colors in another adjacent column of the sub-pixels. That is, the display device provided by the embodiments of the present disclosure adopts a triple gate driving architecture, and the triple gate driving architecture may be as shown in FIG. 2.

The timing controller of a display device is improved by the embodiments of the present disclosure, and the timing controller includes a driving module. The driving module is configured to achieve the following driving.

Switches of (M+1)-th row of the sub-pixels are controlled to be turned on or off. Switches of M-th row of the sub-pixels and switches of a (M+2)-th row of the sub-pixels are simultaneously controlled to be turned on or off. Switches of four adjacent rows of the sub-pixels with a same color are sequentially driven to be turned on or off.

M is a positive integer and M+2 is a multiple of 3. A turned-on time of the switches of the M-th row of the sub-pixels is later than a turned-on time of the switches of the (M+1)-th row of the sub-pixels. Optionally, the turned-on time of the M-th row of the sub-pixels in the display panel differs from the turned-on time of the (M+1)-th row of the sub-pixels by one unit time. The turned-on time of the (M+1)-th row of the sub-pixels in the display panel differs from the turned-on time of the (M+2)-th row of the sub-pixels by one unit time.

Accordingly, the embodiments of the present disclosure provide a driving method of the display device, the driving method including:
controlling the switches of (M+1)-th row of the sub-pixels to be turned on or off, and simultaneously controlling the switches of M-th row of the sub-pixels and the switches of a (M+2)-th row of the sub-pixels to be turned on or off, and sequentially driving the switches of four adjacent rows of the sub-pixels with the same color to be turned on or off.

M is a positive integer and M+2 is a multiple of 3. A turned-on time of the switches of the M-th row of the sub-pixels is later than a turned-on time of the switches of the (M+1)-th row of the sub-pixels. Optionally, the turned-on time of the M-th row of the sub-pixels in the display panel is different from the turned-on time of the (M+1)-th row of the sub-pixels by one unit time. The turned-on time of the (M+1)-th row of the sub-pixels in the display panel is different from the turned-on time of the (M+2)-th row of the sub-pixels by one unit time.

It should be understood that under the triple gate driving architecture, the display panel in the display device includes at least 12 clock signals CK1 to CK12, that is, the first row of sub-pixels to the twelfth row of sub-pixels in the display panel are divided into a group of sub-pixels. The twelve clock signals are connected to the twelve rows of sub-pixels in the group of sub-pixels in one-to-one correspondence through the first scanning lines G1 to the twelfth scanning lines G12, respectively.

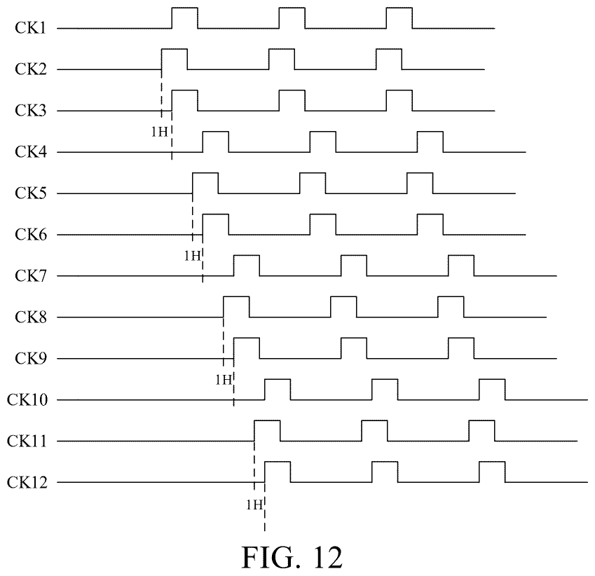

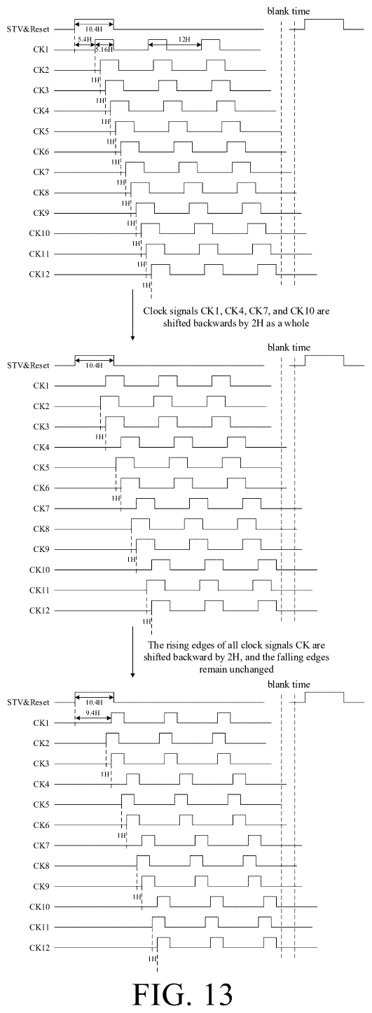

As shown in FIG. 12, the clock signals CK1, CK4, CK7, and CK10 all correspond to the blue sub-pixels B. The clock signals CK2, CK5, CK8, and CK11 all correspond to the green sub-pixels G. The clock signals CK3, CK6, CK9, and CK12 all correspond to the red sub-pixels R. As shown in FIG. 13, in the embodiments of the present disclosure, on the basis of the conventional driving as shown in FIG. 6, the clock signal corresponding to the blue sub-pixel B is shifted backward by two unit time (i.e., 2H) as a whole, that is, the clock signals CK1, CK4, CK7, and CK10 are shifted backward by two unit time (i.e., 2H) as a whole. Thus, as shown in FIG. 12 or FIG. 13, the switches of the M-th row of the sub-pixels and the (M+2)-th row of the sub-pixels in the display panel are simultaneously turned on, and the switches of the M-th row of the sub-pixels and the (M+2)-th row of the sub-pixels are simultaneously turned off. M is a positive integer, and M+2 is a multiple of 3. The M-th row of the sub-pixels correspond to the blue sub-pixels B, and the (M+2)-th row of the sub-pixels correspond to the red sub-pixels R.

Based on this, as shown in FIG. 12 or FIG. 13, the rising edges of the clock signals CK1, CK4, CK7, and CK10 corresponding to the blue sub-pixels B differ from the rising edges of the clock signals CK2, CK5, CK8, and CK11 corresponding to the green sub-pixels G by one unit time (i.e., 1H), respectively. That is, the turned-on time of the M-th row of the sub-pixels (blue sub-pixels B) and the turned-on time of the (M+1)-th row of the sub-pixels (green sub-pixels G) in the display panel are different by one unit time (i.e. 1H). Further, as shown in FIG. 12 or FIG. 13, the rising edges of the clock signals CK2, CK5, CK8, and CK11 corresponding to the green sub-pixels G and the rising edges of the clock signals CK3, CK6, CK9, and CK12 corresponding to the red sub-pixels R are also different by one unit time (i.e., 1H), respectively. That is, the turned-on time of the (M+1)-th row of the sub-pixels (green sub-pixels G) and the turned-on time of the (M+2)-th row of the sub-pixels (red sub-pixels R) in the display panel are different by one unit time (i.e., 1H). The turned-on time of the (M+1)-th row of the sub-pixels is earlier than the turned-on time of the M-th row of the sub-pixels and the (M+2)-th row of the sub-pixels. As shown in FIG. 12 or FIG. 13, the turned-on time of the green sub-pixels G is one unit time (1H) earlier than the turned-on time of the blue sub-pixels B and the red sub-pixels R.

Further, in the embodiments of the present disclosure, the switches of four adjacent rows of sub-pixels with the same color are sequentially controlled to be turned on or off. That is, as shown in FIG. 12 or FIG. 13, the switches of a plurality of rows of blue sub-pixels B are sequentially controlled to be turned on or off. The switches of a plurality of rows of green sub-pixels B are sequentially controlled to be turned on or off. The switches of a plurality of rows of red sub-pixels B are sequentially controlled to be turned on or off. Based on FIG. 12 or FIG. 13, the driving timing of clock signals CK1 to CK12 in the embodiments of the present disclosure is CK2→CK1/CK3→CK5→CK4/CK6→CK8→CK7/CK9→CK11→CK10/CK12.

In the embodiments of the present disclosure, on the basis that the clock signal corresponding to the blue sub-pixels B is shifted backward by 2 unit time (i.e. 2H) as a whole, the rising edges of all clock signals are shifted backward by 2 unit time while the falling edges are maintained unchanged, so as to keep the phase relationship between the pixel charging time and the clock signal unchanged. As shown in FIG. 13, in the embodiments of the present disclosure, a complete clock cycle from turning on to turning off of the switch of the sub-pixel is 12 unit time. Under the condition that the rising edges of all clock signals are shifted backward by 2 unit time while the falling edges are maintained unchanged, there is a difference of 3.16 unit time (i.e. 3.16 H) from a rising edge of the clock signal to an adjacent falling edge. That is, the duration of all sub-pixel switches being in the turned-on state is 3.16 unit time (i.e. 3.16 H). Furthermore, there is a difference of 8.84 unit time (i.e. 8.84 H) from a falling edge to an adjacent rising edge of the clock signal. That is, the duration of all sub-pixel switches being in the turned-off state is 8.84 unit time (i.e. 8.84 H).

Based on the above two-step shift, that is, first, the entire clock signals (CK1, CK4, CK7, and CK10) corresponding to the blue sub-pixels B are shifted backward by two unit time (i.e. 2H), and then the rising edges of all the clock signals (CK1 to CK12) are shifted backward by two unit time (i.e. 2H), and the falling edges are maintained unchanged. In a frame display picture, a first one rising edge of a first one clock signal CK1 differs from a rising edge of a frame start signal or the rising edge of the reset signal of the gate driving circuit by 9.4 unit time (i.e. 9.4 H). A first one rising edge of a second one clock signal CK2 differs from the rising edge of the frame start signal or the rising edge of the reset signal of the gate driving circuit by 8.4 unit time (i.e., 8.4 H). That is, in a frame display picture, a first one turned-on time of the switches of a first one row of sub-pixels differs from the rising edge of the frame start signal or the rising edge of the reset signal of the gate driving circuit by 9.4 unit time (i.e. 9.4 H). In a frame display picture, a first one turned-on time of the switches of a second one row of sub-pixels differs from the rising edge of the frame start signal or the rising edge of the reset signal of the gate driving circuit by 8.4 unit time (i.e. 8.4 H). The rising edge and the falling edge of the frame start signal differ by 10.4 unit time (i.e. 10.4 H). That is, the high level duration of the frame start signal is 10.4 unit time (i.e. 10.4 H). The rising edge and falling edge of the reset signal differ by 10.4 unit time (i.e. 10.4 H). That is, the high level duration of the reset signal is 10.4 unit time (i.e. 10.4 H).

As shown in FIG. 13, the rising edge of the first clock signal CK1 differs from the frame start signal STV or the reset signal Reset by 5.4 unit time (i.e., 5.4 H) under conventional driving. However, the first clock signal CK1 in the embodiments of the present disclosure is shifted backward by 2 unit time (i.e. 2H) as a whole, and the rising edge is shifted backward by 2 unit time (i.e., 2H). Therefore, in the embodiments of the present disclosure, the first one rising edge of the first one clock signal CK1 differs from the rising edge of the frame start signal STV or the rising edge of the reset signal Reset by 9.4 unit time (i.e. 9.4 H).

As shown in FIG. 13, the rising edge of the second one clock signal CK2 differs from the frame start signal STV or the reset signal Reset by 6.4 unit time (i.e., 6.4 H) under conventional driving. However, the first one rising edge of the second one clock signal CK2 in the embodiments of the present disclosure is shifted backward by 2 unit time (i.e., 2H). Therefore, the first one rising edge of the second one clock signal CK2 differs from the rising edge of the frame start signal STV or the rising edge of the reset signal Reset by 8.4 unit time (i.e., 8.4 H).

In some embodiments, the gate driving circuit includes a plurality of cascaded gate driving units. An M-th stage of the gate driving units is electrically connected to an M-th scanning line. The M-th stage of the gate driving units outputs an M-th scanning signal. The M-th scanning signal is configured to drive the M-th scanning line. Based on the timing control method improved by the embodiments of the present disclosure, the driving module in the timing controller is further configured to achieve the following driving.

The switches of the (M+1)-th row of the sub-pixels is controlled to be turned on or off according to a (M+1)-th scanning signal. The switches of the M-th row of the sub-pixels is controlled to be turned on or off according to an M-th scanning signal. The switches of the (M+2)-th row of the sub-pixels is controlled to be turned on or off according to a (M+2)-th scanning signal.

The switches of the M-th row of the sub-pixels is controlled to be turned on or off according to the M-th scanning signal. Switches of a (M+3)-th row of the sub-pixels is controlled to be turned on or off according to a (M+3)-th scanning signal. Switches of a (M+6)-th row of the sub-pixels is controlled to be turned on or off according to a (M+6)-th scanning signal. Switches of a (M+9)-th row of the sub-pixels is controlled to be turned on or off according to a (M+9)-th scanning signal.

The M-th scanning signal is same as the (M+2)-th scanning signal. A level pull-up time of the M-th scanning signal is later than a level pull-up time of the (M+1)-th scanning signal. A level pull-up time of the (M+3)-th scanning signal is later than the level pull-up time of the (M+1)-th scanning signal. A level pull-up time of the (M+6)-th scanning signal is later than the level pull-up time of the (M+3)-th scanning signal. A level pull-up time of a (M+9)-th scanning signal is later than the level pull-up time of the (M+6)-th scanning signal.

Accordingly, the driving method of the display device according to the embodiments of the present disclosure further includes the following steps.

The switches of the (M+1)-th row of the sub-pixels is controlled to be turned on or off according to a (M+1)-th scanning signal. The switches of the M-th row of the sub-pixels is controlled to be turned on or off according to an M-th scanning signal. The switches of the (M+2)-th row of the sub-pixels is controlled to be turned on or off according to a (M+2)-th scanning signal.

The switches of the M-th row of the sub-pixels is controlled to be turned on or off according to the M-th scanning signal. Switches of a (M+3)-th row of the sub-pixels is controlled to be turned on or off according to a (M+3)-th scanning signal. Switches of a (M+6)-th row of the sub-pixels is controlled to be turned on or off according to a (M+6)-th scanning signal. Switches of a (M+9)-th row of the sub-pixels is controlled to be turned on or off according to a (M+9)-th scanning signal.

The M-th scanning signal is same as the (M+2)-th scanning signal. A level pull-up time of the M-th scanning signal is later than a level pull-up time of the (M+1)-th scanning signal. A level pull-up time of the (M+3)-th scanning signal is later than the level pull-up time of the (M+1)-th scanning signal. A level pull-up time of the (M+6)-th scanning signal is later than the level pull-up time of the (M+3)-th scanning signal. A level pull-up time of a (M+9)-th scanning signal is later than the level pull-up time of the (M+6)-th scanning signal.

In the embodiments of the present disclosure, each stage of the gate driving units includes a pull-up module, and the pull-up module may be connected to a clock signal and output a scanning signal. The first stage of the gate driving units is connected to the first clock signal CK1 and outputs the first scanning signal G(1). The second stage of the gate driving units is connected to the second clock signal CK2 and outputs the second scanning signal G(2). By analogy, the twelfth stage of the gate driving units is connected to the twelfth clock signal CK12 and outputs the twelfth scanning signal G(12).

Based on this, the gate driving circuit includes at least 12 stages of the gate driving units. Taking the first 12 stages of the gate driving units of the gate driving circuit as an example, the working process of the gate driving circuit may be as follows.

The frame start signal STV or the reset signal Reset supplies a high potential, and the circuit nodes Q(N) in the first to sixth stages of the gate driving units are pulled down to the low potential.

The first clock signal CK1 and the third clock signal CK3 supply high potentials, the first stage of the gate driving units outputs the first scanning signal G(1), and the third stage gate of the driving units outputs the third scanning signal G(3).

The second clock signal CK2 supplies a high potential, and the second stage of the gate driving units outputs the second scanning signal G(2).

The fourth clock signal CK4 and the fifth clock signal CK5 supply high potentials, the fourth stage of the gate driving units outputs the fourth scanning signal G(4), and the fifth stage gate driving unit outputs the fifth scanning signal G(5).

The sixth clock signal CK6 supplies a high potential, and the sixth stage of the gate driving units outputs the sixth scanning signal G(6).

The first scanning signal G(1) is connected to the seventh stage of the gate driving units. The circuit node Q(N) of the seventh stage of the gate driving units is pulled up to a high potential. The seventh clock signal supplies the high potential, and the seventh stage of the gate driving units outputs the seventh scanning signal G(7). The third scanning signal G(3) is connected to the ninth stage of the gate driving units. The circuit node Q(N) of the ninth stage of the gate driving units is pulled up to a high potential. The ninth clock signal supplies the high potential, and the ninth stage of the gate driving units outputs the ninth scanning signal G(9).

The second scanning signal G(2) is connected to the eighth stage of the gate driving units. The circuit node Q(N) of the eighth stage of the gate driving units is pulled up to a high potential. The eighth clock signal supplies the high potential, and the eighth stage of the gate driving units outputs the eighth scanning signal G(8).

The fourth scanning signal G(4) is connected to the tenth stage of the gate driving units. The circuit node Q(N) of the tenth stage of the gate driving units is pulled up to a high potential. The tenth clock signal supplies the high potential, and the tenth stage of the gate driving units outputs the tenth scanning signal G(10). The sixth scanning signal G(6) is connected to the twelfth stage of the gate driving units. The circuit node Q(N) of the twelfth stage of the gate driving units is pulled up to a high potential. The twelfth clock signal supplies the high potential, and the twelfth stage of the gate driving units outputs the twelfth scanning signal G(12).

The fifth scanning signal G(5) is connected to the eleventh stage of the gate driving units. The circuit node Q(N) of the eleventh stage of the gate driving units is pulled up to a high potential. The eleventh clock signal supplies the high potential, and the eleventh stage of the gate driving units outputs the eleventh scanning signal G(11).

In condition of the gate driving circuit including 12 or more stages of the gate driving units, it can be sequentially cycled according to the working procedure described in the above embodiments. Optionally, the pull-up module of the gate driving unit may output two signals, namely, a scanning signal and a cascade signal, respectively, with the same timing. The cascade signal may also be used for pull-up or pull-down control of other gate driving units.

In some embodiments, each stage gate drive unit includes a pull-up control module, a pull-up module, and a pull-down module. The pull-up control module is electrically connected to the pull-up control module and the pull-down control module through a circuit node.

The pull-up control module of the N-th stage of the gate driving units is connected to the (N−6)-th scanning signal, and is used for pulling up the level of the circuit node Q(N) of the N-th stage of the gate driving units to a high level according to the (N−6)-th scanning signal.

The pull-down module of the N-th stage of the gate driving units is connected to the (N+8)-th scanning signal, and is used for pulling down the level of the circuit node Q(N) of the N-th stage of the gate driving units to a low level according to the (N+8)-th scanning signal.

The pull-up module of the N-th stage of the gate driving units is used for outputting an N-th scanning signal according to a level state of the circuit node Q(N) of the N-th stage of the gate driving units.

N is a positive integer greater than or equal to 6.

Accordingly, the driving method of the display device according to the embodiments of the present disclosure further includes the following steps.

The level of the circuit node Q(N) of the N-th stage of the gate driving units is pulled up to a high level according to the (N−6)-th scanning signal. The level of the circuit node Q(N) of the N-th stage of the gate driving units is pulled down to a low level according to the (N+8)-th scanning signal.

The N-th scanning signal is output according to the level state of the circuit node Q(N) of the N-th stage of the gate driving units.

N is a positive integer greater than or equal to 6.

For example, as shown in FIG. 16, the pull-up module 1610 of the N-th stage of the gate driving units includes a transistor T21. The transistor T21 is connected to the N-th clock signal CK(N) and outputs the N-th scanning signal G(N). The pull-up control module 1620 of the N-th stage of the gate driving units includes a transistor T11. The transistor T11 is connected to the (N−6)-th scanning signal G(N−6). The pull-down module 1630 of the N-th stage of the gate driving units includes a transistor T31 and a transistor T41. The transistor T31 and the transistor T41 is connected to the (N+8)-th scanning signal G(N+8) or the (N+8)-th stage transmission signal ST (N+8).

Optionally, the N-th scanning signal being output according to the level state of the circuit node Q(N) of the N-th stage of the gate driving units, includes the following steps.

The level of the N-th scanning signal is pulled up to a high level at a level pull-up time of the circuit node Q(N) of the N-th stage of the gate driving units.

The level of the N-th scanning signal is pulled down to a low level at the level pull-down time of the circuit node Q(N) of the N-th stage of the gate driving units.

Optionally, the level of the circuit node Q(N) of the N-th stage of the gate driving units being pulled up to the high level includes: pulling up the level of the circuit node Q(N) of the N-th stage of the gate driving units to a high level at the level pull-up time of the (N−6)-th scanning signal. The level of the circuit node Q(N) of the N-th stage of the gate driving units being pulled down to a low level according to the (N+8)-th scanning signal includes: pulling down the level of the circuit node Q(N) of the N-th stage of the gate driving units to a low level at the level pull-up time of the (N+8)-th scanning signal.

That is, the rising edge of the N-th scanning signal coincides with the falling edge of the (N−6)-th scanning signal. The falling edge of the N-th scanning signal coincides with the rising edge of the (N+8)-th scanning signal. N is a positive integer greater than or equal to 6.

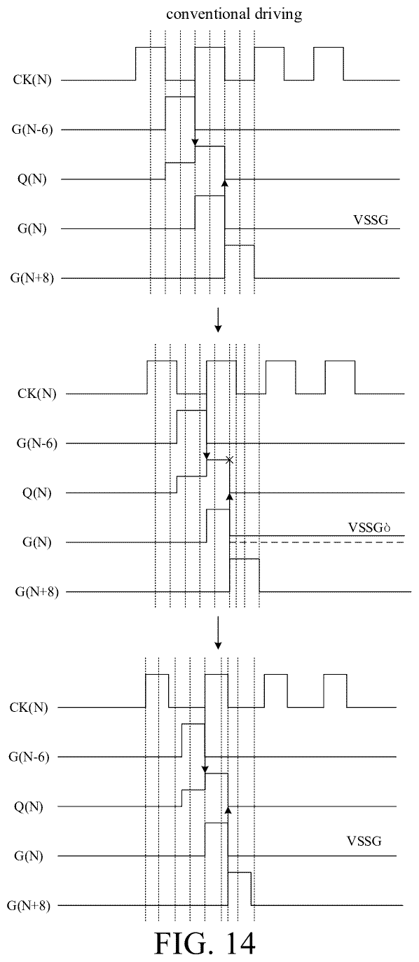

As shown in FIG. 14, the N-th scanning signal refers to the signal G(N), the (N−6)-th scanning signal refers to the signal G(N−6), and the (N+8)-th scanning signal refers to the signal G(N+8). Taking the signal G(N) corresponding to the blue sub-pixels B as an example, the signal G(N) is output by the pull-up module of the N-th stage of the gate driving units. The pull-up control module of the N-th stage of the gate driving units is connected to the signal G(N−6), and the signal G(N−6) also corresponds to the blue sub-pixels B. The pull-down module of the N-th stage of the gate driving units is connected to the signal G(N+8), and the signal G(N+8) corresponds to the red sub-pixels R. Since the rising edge of the clock signal corresponding to the red sub-pixels R is shifted backward by two unit time (i.e., 2H), the rising edge of the signal G(N+8) connected to the pull-down module is also shifted backward by two unit time (i.e., 2H). Since the clock signal corresponding to the blue sub-pixels B is shifted backward by two unit time (i.e., 2H) as a whole, after the signal G(N+8) is pulled up to the high level, the clock signal CK(N) signal is just at the low potential, the falling edge of the signal G(N) coincides with the rising edge of the signal G(N+8), and the signal G(N) can be smoothly reduced to the original low potential VSSG. The pull-up module of the N-th stage of the gate driving units is connected to the N-th clock signal CK(N). In the embodiments of the present disclosure, the N-th clock signal CK(N) is at a low level at the pull-down time of the N-th scanning signal G(N).

In the above embodiments, for the N-th stage of the gate driving units, the level of the circuit node Q(N) of the N-th stage of the gate driving units is pulled up to a high level at the level pull-down time of the (N−6)-th scanning signal. That is, the charging start time of the circuit node Q(N) of the N-th stage of the gate driving units coincides with the falling edge of the (N−6)-th scanning signal. The level of the circuit node Q(N) of the N-th stage of the gate driving units is pulled down to a low level at the level pull-up time of the (N+8)-th scanning signal. That is, the charging end time of the circuit node Q(N) of the N-th stage of the gate driving units coincides with the rising edge of the (N+8)-th scanning signal.

In some embodiments, the pull-up control module of the N-th stage of the gate driving units is connected to the (N−6)-th scanning signal, and drives the circuit node Q(N) of the N-th stage of the gate driving units to precharge during the high level duration of the (N−6)-th scanning signal.

That is, in the embodiments of the present disclosure, the circuit node Q(N) of the gate driving unit is precharged. The precharge start time of the circuit node Q(N) of the N-th stage of the gate driving units coincides with the rising edge of the (N−6)-th scanning signal. The precharge end time of the circuit node Q(N) of the N-th stage of the gate driving units coincides with the falling edge of the (N−6)-th scanning signal.

As shown in FIG. 14, the embodiments of the present disclosure precharges and charges the circuit node Q(N) of the N-th stage of the gate driving units. The circuit node Q(N) is precharged at the rising edge of the (N−6)-th scanning signal G(N−6). That is, the precharge start time of Q(N) coincides with the rising edge of the signal G(N−6). The precharge of the circuit node Q(N) is stopped at the falling edge of the (N−6)-th scanning signal G(N−6). That is, the precharge end time of the circuit node Q(N) coincides with the falling edge of the signal G(N−6). The circuit node Q(N) is charged at the falling edge of the (N−6)-th scanning signal G(N−6). That is, the charging start time of the circuit node Q(N) coincides with the falling edge of the signal G(N−6). The charging of the circuit node Q(N) is stopped at the rising edge of the (N+8)-th scanning signal. That is, the charging end time of the circuit node Q(N) coincides with the rising edge of the signal G(N+8).

Optionally, the duration of one unit time described in the embodiments of the present disclosure is 2.47 s. Optionally, the unit time refers to the time required to scan a row of sub-pixels.

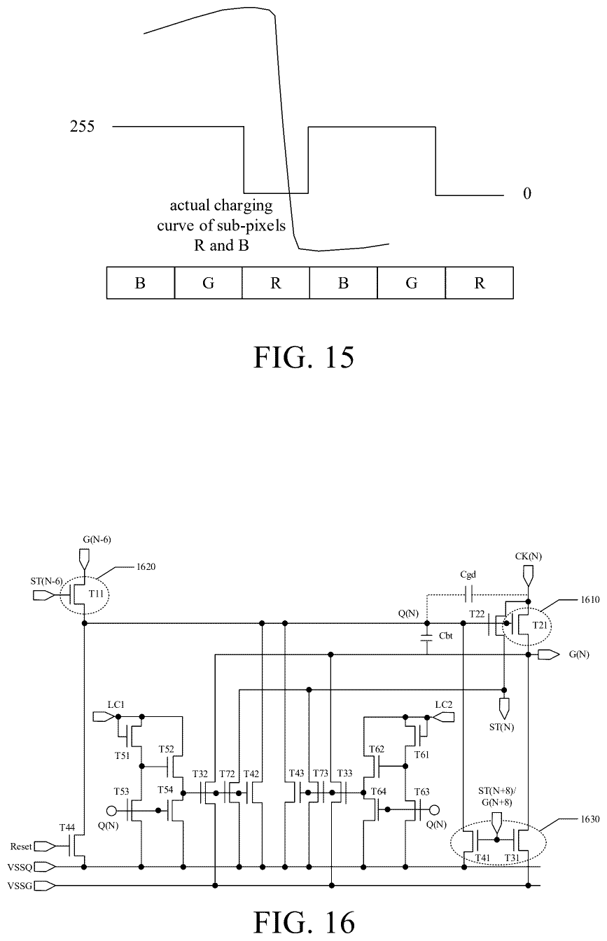

As shown in FIG. 15, according to the driving method provided by the embodiments of the present disclosure, since the gate slews corresponding to the blue sub-pixels B and the red sub-pixels R are completely consistent, the mischarging condition of the blue sub-pixels is improved, and a pure green display effect can be exhibited under the color mixing pattern with (0,255,255). In condition of inputting the color mixing pattern with (0, x, y), since the blue sub-pixel B is not turned on for charging, the picture will only appear green in the end, which can eliminate the brightness influence of adjacent colors. In this condition, a simple rising area or falling area environment may be quickly constructed by specially setting different G/B gray scale combinations, and all rising areas or falling areas in the LOD LUT may be accurately obtained by comparing the brightness difference with the brightness difference under light load.

In summary, the embodiments of the present disclosure improve the problem that line overdrive may not accurately charge and compensate in the triple gate driving architecture. The accuracy and efficiency of charging compensation of the display device is improved. The image quality problems of watermarks and uneven transitions under various complex RIG/B gray scale combination is improved, so as to improve the overall image quality.

The display device and the driving method thereof provided by the embodiments of the present disclosure are described in detail above. The principle and implementations of the present disclosure are described in this specification by using specific examples. The description about the foregoing embodiments is merely provided to help understand the method and core ideas of the present disclosure. In addition, those skilled in the art can make modifications in terms of the specific implementations and application scopes according to the ideas of the present disclosure. Therefore, the content of this specification shall not be construed as a limit to the present disclosure.

What is claimed is:

1. A driving method of a display device, wherein the display device comprises a display panel comprising a plurality of scanning lines, a plurality of data lines, and a plurality of sub-pixels arranged in an array, each of the sub-pixels is electrically connected to one of the scanning lines and one of the data lines, colors of a same row of the sub-pixels are same, colors of adjacent rows of the sub pixels are different, one of the data lines is electrically connected to three consecutive sub-pixels having different colors in a column of the sub-pixels, and is further electrically connected to another three rows of three consecutive sub-pixels having different colors in another adjacent column of the sub-pixels; and
the driving method comprises:
controlling switches of a (M+1)-th row of the sub-pixels to be turned on or off, and
simultaneously controlling switches of an M-th row of the sub-pixels and switches of a (M+2)-th row of the sub-pixels to be turned on or off, and sequentially driving switches of four adjacent rows of the sub-pixels having a same color to be turned on or off;
wherein a turned-on time of the switches of the M-th row of the sub-pixels is later than a turned-on time of the switches of the (M+1)-th row of the sub-pixels; and M is a positive integer and M+2 is a multiple of 3.

2. The driving method of the display device of claim 1, wherein the display device comprises a gate driving circuit comprising a plurality of cascaded gate driving units, an M-th stage of the gate driving units is electrically connected to an M-th scanning line, and the M-th stage of the gate driving units outputs an M-th scanning signal for driving the M-th scanning line;
the controlling the switches of the (M+1)-th row of the sub-pixels to be turned on or off, and the simultaneously controlling the switches of the M-th row of the sub-pixels and the switches of the (M+2)-th row of the sub-pixels to be turned on or off, comprises:
controlling the switches of the (M+1)-th row of the sub-pixels to be turned on or off according to a (M+1)-th scanning signal, controlling the switches of the M-th row of the sub-pixels to be turned on or off according to an M-th scanning signal, and controlling the switches of the (M+2)-th row of the sub-pixels to be turned on or off according to a (M+2)-th scanning signal;
the sequentially driving switches of the four adjacent rows of the sub-pixels having the same color to be turned on or off, comprises:
controlling the switches of the M-th row of the sub-pixels to be turned on or off according to the M-th scanning signal, controlling switches of a (M+3)-th row of the sub-pixels to be turned on or off according to a (M+3)-th scanning signal, controlling switches of a (M+6)-th row of the sub-pixels to be turned on or off according to a (M+6)-th scanning signal, and controlling switches of a (M+9)-th row of the sub-pixels to be turned on or off according to a (M+9)-th scanning signal; and
the M-th scanning signal is same as the (M+2)-th scanning signal; a level pull-up time of the M-th scanning signal is later than a level pull-up time of the (M+1)-th scanning signal; a level pull-up time of the (M+3)-th scanning signal is later than the level pull-up time of the (M+1)-th scanning signal; a level pull-up time of the (M+6)-th scanning signal is later than the level pull-up time of the (M+3)-th scanning signal; and a level pull-up time of a (M+9)-th scanning signal is later than the level pull-up time of the (M+6)-th scanning signal.

3. The driving method of the display device of claim 2, wherein each stage of the gate driving units comprises a pull-up control module, a pull-up module, and a pull-down module; the pull-up control module is electrically connected to the pull-up module and the pull-down module through a circuit node; the pull-up control module of an N-th stage of the gate driving units is connected to a (N−6)-th scanning signal, the pull-up module of an N-th stage of the gate driving units outputs an N-th scanning signal, the pull-down module of the N-th stage of the gate driving units is connected to a (N+8)-th scanning signal, and N is a positive integer greater than or equal to 6; and the driving method further comprises:
pulling up a level of the circuit node of the N-th stage of the gate driving units to a high level according to the (N−6)-th scanning signal, and pulling down a level of the circuit node of the N-th stage of the gate driving units to a low level according to the (N+8)-th scanning signal; and
outputting the N-th scanning signal according to a level state of the circuit node of the N-th stage of the gate driving units.

4. The driving method of the display device of claim 3, wherein the outputting the N-th scanning signal according to the level state of the circuit node of the N-th stage of the gate driving units comprises:
pulling up a level of the N-th scanning signal to a high level at a level pull-up time of the circuit node of the N-th stage of the gate driving units;
pulling down the level of the N-th scanning signal to a low level at a level pull-down time of the circuit node of the N-th stage of the gate driving units.

5. The driving method of the display device of claim 4, wherein the pull-up module of the N-th stage of the gate driving units is connected to an N-th clock signal; and the N-th clock signal is at a low level at a level pull-down time of the N-th scanning signal.

6. The driving method of the display device of claim 3, wherein the pulling up the level of the circuit node of the N-th stage of the gate driving units to the high level according to the (N−6)-th scanning signal, and the pulling down the level of the circuit node of the N-th stage of the gate driving units to the low level according to the (N+8)-th scanning signal comprise:
pulling up the level of the circuit node of the N-th stage of the gate driving units to the high level at a level pull-up time of the (N−6)-th scanning signal; and
pulling down the level of the circuit node of the N-th stage of the gate driving units to the low level at a level pull-up time of the (N+8)-th scanning signal.

7. The driving method of the display device of claim 6, wherein the driving method further comprises:
driving the circuit node of the N-th stage of the gate driving units to be precharged during a high level duration of the (N−6)-th scanning signal.

8. A display device, comprising a display panel, a source driving circuit, a gate driving circuit, and a timing controller, wherein the timing controller is electrically connected to the source driving circuit and the gate driving circuit, the display panel comprises a plurality of scanning lines, a plurality of data lines, and a plurality of sub-pixels arranged in an array, the source driving circuit is electrically connected to the data lines, the gate driving circuit is electrically connected to the scanning lines, each of the sub-pixels is electrically connected to one of the scanning lines and one of the data lines, colors of a same row of the sub-pixels are same, colors of adjacent rows of the sub pixels are different, one of the data lines is electrically connected to three consecutive sub-pixels having different colors in a column of the sub-pixels, and is further electrically connected to another three rows of three consecutive sub-pixels having different colors in another adjacent column of the sub-pixels; and
the timing controller is configured to:
control switches of a (M+1)-th row of the sub-pixels to be turned on or off; and
simultaneously control switches of an M-th row of the sub-pixels and switches of a (M+2)-th row of the sub-pixels to be turned on or off, and sequentially drive switches of four adjacent rows of the sub-pixels having a same color to be turned on or off,
wherein a turned-on time of the switches of the M-th row of the sub-pixels is later than a turned-on time of the switches of the (M+1)-th row of the sub-pixels; and M is a positive integer and M+2 is a multiple of 3.

9. The display device of claim 8, wherein the gate driving circuit comprises a plurality of cascaded gate driving units, an M-th stage of the gate driving units is electrically connected to an M-th scanning line, and the M-th stage of the gate driving units outputs an M-th scanning signal for driving the M-th scanning line;
the timing controller is configured to:
control the switches of the (M+1)-th row of the sub-pixels to be turned on or off according to a (M+1)-th scanning signal, control the switches of the M-th row of the sub-pixels to be turned on or off according to an M-th scanning signal, and control the switches of the (M+2)-th row of the sub-pixels to be turned on or off according to a (M+2)-th scanning signal;
control the switches of the M-th row of the sub-pixels to be turned on or off according to the M-th scanning signal, control switches of a (M+3)-th row of the sub-pixels to be turned on or off according to a (M+3)-th scanning signal, control switches of a (M+6)-th row of the sub-pixels to be turned on or off according to a (M+6)-th scanning signal, and control switches of a (M+9)-th row of the sub-pixels to be turned on or off according to a (M+9)-th scanning signal; and
the M-th scanning signal is same as the (M+2)-th scanning signal; a level pull-up time of the M-th scanning signal is later than a level pull-up time of the (M+1)-th scanning signal; a level pull-up time of the (M+3)-th scanning signal is later than the level pull-up time of the (M+1)-th scanning signal; a level pull-up time of the (M+6)-th scanning signal is later than the level pull-up time of the (M+3)-th scanning signal;
and a level pull-up time of a (M+9)-th scanning signal is later than the level pull-up time of the (M+6)-th scanning signal.

10. The display device of claim 9, wherein each stage of the gate driving units comprises a pull-up control module, a pull-up module, and a pull-down module, and the pull-up control module is electrically connected to the pull-up module and the pull-down module through a circuit node;
the pull-up control module of the N-th stage of the gate driving units is connected to the (N−6)-th scanning signal, and is configured to pull up a level of the circuit node of the N-th stage of the gate driving units to a high level according to the (N−6)-th scanning signal;
the pull-down module of the N-th stage of the gate driving units is connected to the (N+8)-th scanning signal, and is configured to pull-down a level of the circuit node of the N-th stage of the gate driving units to a low level according to the (N+8)-th scanning signal;
the pull-up module of the N-th stage of the gate driving units is configured to output the N-th scanning signal according to a level state of the circuit node of the N-th stage of the gate driving units; and
N is a positive integer greater than or equal to 6.
